(19) United States
(12) Patent Application Publication
(10) Pub. No.: US 2019/0163877 A1
(43) Pub. Date: May 30, 2019

(54) DECISION SUPPORT FOR EFFECTIVE LONG-TERM DRUG THERAPY

(71) Applicant: INTERNATIONAL BUSINESS MACHINES CORPORATION, Armonk, NY (US)

(72) Inventors: Elinor Dehan, Haniel (IL); AMIT GRUBER, Tel Aviv (IL); Chen Yanover, Zichron Yaakov (IL)

(21) Appl. No.: 15/822,454

(22) Filed: Nov. 27, 2017

(51) Int. Cl. G06F 19/00; G06N 7/08; G06N 99/00

(52) U.S. Cl. CPC G06F 19/3481; G06N 99/005; G06N 7/08; G06F 19/345

(57) ABSTRACT

Embodiments of the present invention disclose a method, a computer program product, and a computer system for decision support in long term therapy. A computer receives a pathogen drug resistance evolution model and retrieves population data. The computer then trains the drug resistance evolution model and identifies parameters corresponding to the drug resistance evolution model based on the retrieved population data. The computer then receives patient data and prescribes a therapy based on the drug resistance evolution model. In addition, the computer observes the results of the prescribed therapy and refines the drug resistance evolution model accordingly.

### BACKGROUND

The present invention relates generally to data analysis, and more particularly to decision support for drug therapy in diseases where continuous therapy is needed.

Treating a patient for a pathogen requires careful selection of the drugs given to the patient due to drug resistant mutations that a pathogen evolves over time. Automated systems for recommending drug treatments exist but these systems only recommend successful short term treatments and ignore long term effects. These long term effects result from the pathogen evolving these drug resistant mutations over time.

### SUMMARY

Embodiments of the present invention disclose a method, a computer program product, and a computer system for decision support for effective long term drug therapy. A computer receives a pathogen drug resistance evolution model and retrieves population data. The computer then trains the drug resistance evolution model and identifies parameters corresponding to the drug resistance evolution model based on the retrieved population data. The computer then receives patient data and prescribes a therapy based on the drug resistance evolution model. In addition, the computer observes the results of the prescribed therapy and refines the drug resistance evolution model accordingly.

### BRIEF DESCRIPTION OF THE SEVERAL VIEWS OF THE DRAWINGS

FIG. 1 depicts a schematic diagram of a decision support system 100, in accordance with an embodiment of the present invention.

FIG. 2 depicts a flowchart illustrating the configuring of decision support program 132 of decision support system 100 in training a generative drug resistance evolution model, in accordance with an embodiment of the present invention.

FIG. 3 depicts a flowchart illustrating the operation of decision support program 132 of decision support system 100 in providing decision support for long term drug therapy based on the drug resistance evolution model, in accordance with an embodiment of the present invention.

FIG. 4 depicts a diagram of a Factorial Hidden Markov Model (HMM) in plates notation, in accordance with an embodiment of the present invention.

FIG. 5 depicts a diagram of a Factorial HMM in plates notation for a multidrug therapy model, in accordance with an embodiment of the present invention.

FIG. 6 depicts a diagram of a special case of Factorial HMM in plates notation, in accordance with an embodiment of the present invention.

FIG. 7 is a block diagram depicting the hardware components of decision support system 100 of FIG. 1, in accordance with an embodiment of the present invention.

FIG. 8 depicts a cloud computing environment, in accordance with an embodiment of the present invention.

FIG. 9 depicts abstraction model layers, in accordance with an embodiment of the present invention.

### DETAILED DESCRIPTION

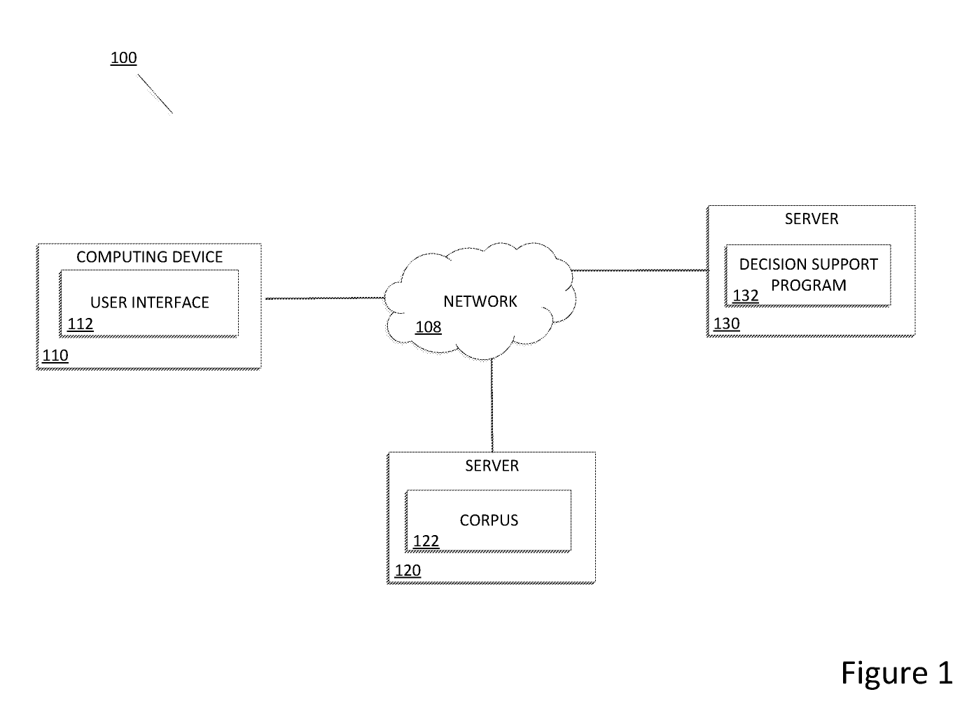

A decision support system 100 in accordance with an embodiment of the invention is illustrated by FIG. 1.

In the example embodiment, network 108 is a communication channel capable of transferring data between connected devices. In the example embodiment, network 108 may be the Internet, representing a worldwide collection of networks and gateways to support communications between devices connected to the Internet. Moreover, network 108 may include, for example, wired, wireless, or fiber optic connections which may be implemented as an intranet network, a local area network (LAN), a wide area network (WAN), or any combination thereof. In further embodiments, network 108 may be a Bluetooth network, a WiFi network, or a combination thereof. In yet further embodiments, network 108 may be a telecommunications network used to facilitate telephone calls between two or more parties comprising a landline network, a wireless network, a closed network, a satellite network, or any combination thereof. In general, network 108 can be any combination of connections and protocols that will support communications between computing device 110, server 120, and server 130.

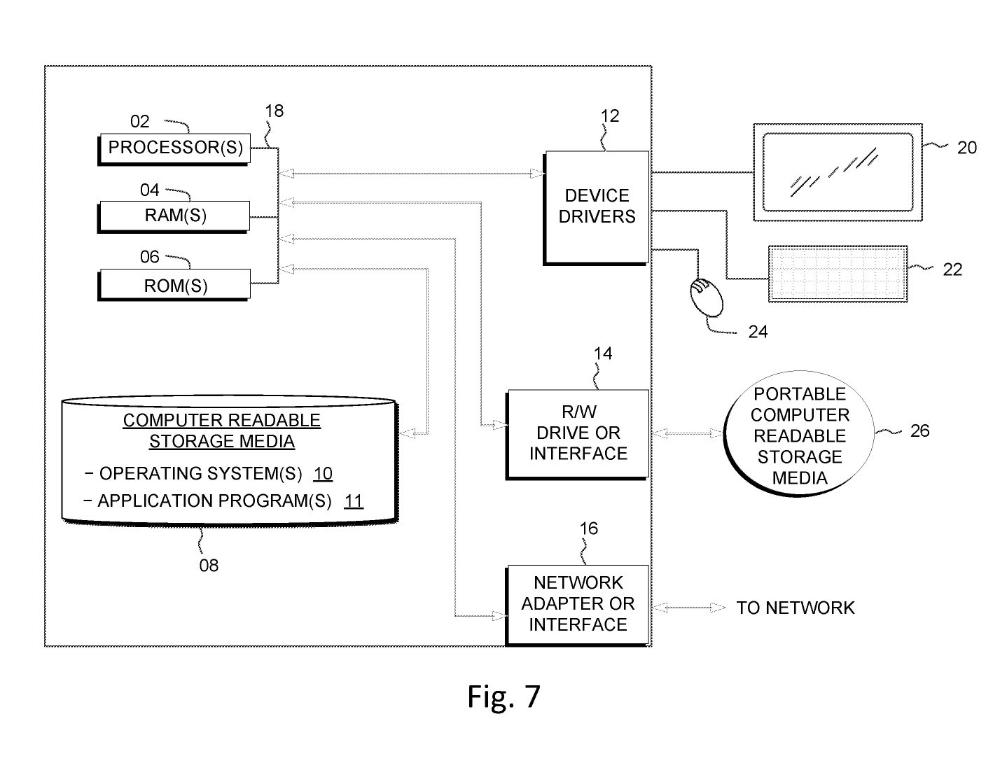

In the example embodiment, computing device 110 includes user interface 112. Computing device 110 may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While computing device 110 is shown as a single device, in other embodiments, computing device 110 may be comprised of a cluster or plurality of computing devices, working together or working separately. Computing device 110 is described in more detail with reference to FIG. 7.

User interface 112 is a software application which allows a user of computing device 110 to interact with computing device 110 as well as other connected devices via network 108. In addition, user interface 112 may be connectively coupled to hardware components, such as those depicted by FIG. 7, for receiving user input, including mice, keyboards, touchscreens, microphones, cameras, and the like. In the example embodiment, user interface 112 is implemented via a web browsing application containing a graphical user interface (GUI) and display that is capable of transferring data files, folders, audio, video, hyperlinks, compressed data, and other forms of data transfer individually or in bulk. In other embodiments, user interface 112 may be implemented via other integrated or standalone software applications and hardware capable of receiving user interaction and communicating with other electronic devices.

In the example embodiment, server 120 includes corpus 122. Server 120 may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While server 120 is shown as a single device, in other embodiments, server 120 may be comprised of a cluster or plurality of computing devices, working together or working separately. Server 120 is described in more detail with reference to FIG. 7.

Corpus 122 is a collection of information contained in files, folders, and other document types. In the example embodiment, corpus 122 may be a corpora of documents which detail bodies of categorized and subject specific data, such as medical, legal, and financial data. In other embodiments, corpus 122 may include uncategorized data of miscellaneous topics. In the example embodiment, corpus 122 may be structured (i.e. have associated metadata), partially structured, or unstructured. Moreover, data within corpus 122 may be written in programming languages of common file formats such as .docx, .doc, .pdf, .rtf, .jpg, .csv, .txt, etc. In further embodiments, corpus 122 may include handwritten and other documents scanned or otherwise converted into electronic form.

In the example embodiment, server 130 includes decision support program 132. Server 130 may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While server 130 is shown as a single device, in other embodiments, server 130 may be comprised of a cluster or plurality of computing devices, working together or working separately. Server 130 is described in more detail with reference to FIG. 7.

In the example embodiment, decision support program 132 is a software application capable of receiving a pathogen drug resistance evolution model, retrieving population data, and training the pathogen drug resistance evolution model. Moreover, decision support program 132 is further capable of receiving patient data, prescribing a therapy based on feeding the patient data into the trained pathogen drug resistance evolution model, and observing the outcome of the prescribed therapy. Lastly, decision support program 132 is capable of refining the pathogen drug resistance evolution model based on the observed outcome of the therapy.

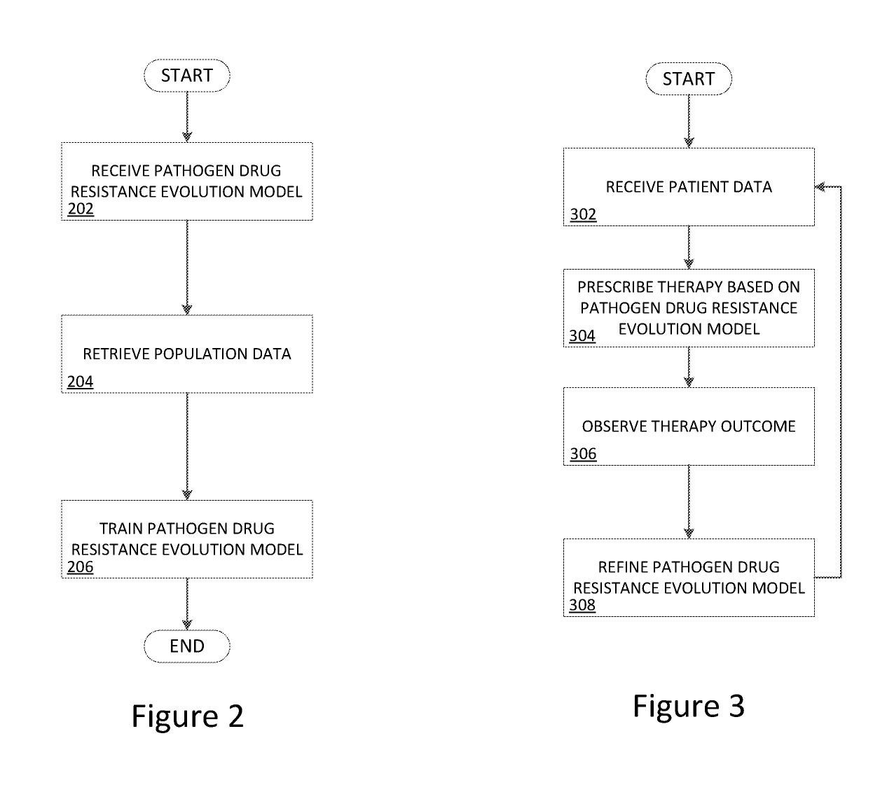

FIG. 2 illustrates the configuring of decision support program 132 of decision support system 100 in training a generative pathogen drug resistance evolution model, in accordance with an embodiment of the present invention. As used herein, “short term” is defined as a duration of one to six months, while “long term” is defined as a duration of more than six months and, more typically, a few years. Decision support program 132 first receives programming defining a generative model (step 202). In the example embodiment, decision support program 132 implements a Factorial Hidden Markov Model (HMM) consisting of multiple chains interconnected through observation. Each chain corresponds to a possible resistance with respect to a specific drug and its evolution over time while the observation connecting the chains is the therapy outcome. More specifically, decision support program 132 models pathogen sensitivity to each available drug as a Markov chain with a hidden state comprising two variables: a binary variable indicating whether a perpetual resistance to that drug has been acquired, and a binary variable indicating the instantaneous existence of a drug resistant mutation. While the example embodiment models pathogen drug resistance evolution utilizing a Factorial HMM, it will be appreciated that other embodiments may implement alternative stochastic models. Moreover, some models may be applicable to a class of pathogens exhibiting similar characteristics, for example models applicable to all bacterial or viral infections, while other models may be exclusive to a particular pathogen. In the example embodiment, decision support program 132 is configured to provide decision support for combined therapy, i.e. receiving multiple drugs at a time, as well as single therapy.

With reference to an illustrative example, suppose a doctor is seeking decision support for long-term HIV treatment. In order to fully appreciate the proceeding example, a brief introduction to HIV is provided herein. HIV is typically treated with combined antiretroviral therapy (CART) comprising 2-3 drugs. If the virus is sensitive to at least one of the compounds in the CART, then the therapy prevents the virus from reproducing and brings HIV levels in the blood, or serum, below detection rates. However, if the patient stops taking the CART or the virus develops resistance to all compounds in the CART, the virus is able to replicate and the level in the serum will rise again. Even when the therapy is successful, however, it does not eradicate the virus from the reservoirs in the body. To that point, if drug resistant mutants are not suppressed in the blood stream and are able to replicate into significant amounts, they may form latent reservoirs, or collections of immune cells, infected by the virus that will not be affected by anti-HIV drugs. Once drug resistant mutants are present in the reservoirs, the virus has acquired persistent/permanent resistance to the drug. As it relates to the drug resistance acquisition described above, HIV exhibits the following characteristics: 1) any resistance to a drug acquired by the pathogen is perpetual; 2) sensitivity to a drug is preserved if the pathogen is not exposed to the drug; and 3) resistance of the pathogen to a drug develops randomly at a specified probability. In the example used herein, the following functions embody the aforementioned characteristics and define the factorial HMM:

Letting K denote the number of available drugs to combat HIV, the model consists of a collection of K such chains. These chains may interact through the treatment outcome as explained by the mathematical functions below where we consider a single chain of drugs k and current time t. Let d_{t,k} be a binary variable denoting whether drug k was taken at time t (d_{t,k}=1 for a drug taken at time t) and let Oₜ be the multi-drug treatment outcome (Oₜ=1 for a successful treatment). Let m_{t,k} be a binary variable representing the existence of mutations resistant to drug k in the serum (m_{t,k},=1 for existence of resistant mutation) and let R_{t,k} be a binary variable representing whether permanent resistance to drug k already exists at time t in the reservoirs of infection (R_{t,k},=1 for permanent resistance). The following functions/equations depict the three aforementioned characteristics of HIV under several common scenarios.

Equation 1 below models the probability of the serum having drug resistant mutations to drug k at time t (m_{t,k}=1) under three different scenarios. Under the first scenario, which embodies characteristic 1 above, when the reservoirs of infection have already acquired permanent resistant to drugs k (R_{t,k}=1), this probability is 1. In the second scenario, and embodying characteristic 3 above, when the pathogen has not acquired permanent resistance to drugs k in the reservoirs of infection (R_{t,k}=0) and the patient is taking drugs k at time t (d_{t,k}=1), we denote this probability by p^{M}. Lastly, the third scenario, which embodies characteristic 2 above, in all other situations the probability of the serum having drug-resistant mutations to drug k at time t is equal to 0.

$$Pr ( {m}_{t , k} = 1 \vert {R}_{t , k} , {d}_{t , k} ) = \{ \begin{matrix}1 if {R}_{t , k} = 1 \\ {p}^{M} if {R}_{t , k} = 0 , {d}_{t , k} = 1 \\ 0 otherwise\end{matrix} \qquad ( 1 )$$

Equation 2 illustrated below models a situation in which a pathogen acquires permanent resistance to drug k within the reservoirs of infection. When drug resistant mutations appear in the serum (mₜ=1) and are not suppressed (Oₜ=0), they may enter the reservoirs of infection and the virus will consequently acquire permanent resistance to drug k (R_{t+1,k}=1). There are two conditions which may lead to this situation: (1) the pathogen has already developed a resistance to drug k, and/or (2) the treatment fails due to evolution of drug resistant mutations. Accordingly, Equation 2 shown below models the probability of the reservoirs of infection developing permanent resistance to drugs k at future time t+1 (R_{t+1,k}=1) under three different scenarios. Let E>0 be a small fixed parameter of the algorithm. Then, under the first scenario, which embodies characteristic 1, the probability of the pathogen developing permanent resistance to drugs k within the reservoirs of infection at future time t+1 (R_{t+1,k}=1) is equal to 1-E, when the reservoirs of infection have already developed permanent resistance to drug k at current time t (R_{t,k}=1). Under the second scenario, which embodies characteristic 2, the probability of the reservoirs of infection developing permanent resistance to drugs k at future time t+1 (R_{t+1,k}=1) is equal to 1−ε if: (1) the pathogen has not developed a permanent resistance to drugs k in the reservoirs of infection at current time t (R_{t,k}=0); (2) the serum has drug-resistant mutations to drug k at time t (m_{t,k}=1); and (3) the current treatment fails (Oₜ=0). Lastly, in the third scenario, the probability of the pathogen developing permanent resistance to drug k at future time t+1 (R_{t+1,k}=0) is equal to ε in all other situations (m_{t,k}=0 and Oₜ=1).

$$Pr ( {R}_{t + 1 , k} = 1 \vert {R}_{t , k} , {m}_{t , k} , {O}_{t} ) = \{ \begin{matrix}1 - ɛ & if {R}_{t , k} = 1 \\ 1 - ɛ & if {R}_{t , k} = 0 , {m}_{t , k} = 1 , {O}_{t} = 0 \\ ɛ & otherwise\end{matrix} \qquad ( 2 )$$

Inevitably, there will be situations in which a patient undergoes previous treatment for a pathogen without the treatment being recorded and the previous treatments are thus unknown to decision support program 132. For such situations, a prior Pr(R_{1,k}=1)=pₖ^{R0} is placed on resistance that had already been acquired by the patient before the first recorded treatment, i.e. before t=1. Such a resistance may be acquired due to past treatments missing from the data, or due to getting initially infected by a drug resistant strain.

With regard to predicting whether a drug therapy treatment will be successful, the example embodiment considers a treatment successful if the virus is suppressed in the serum (i.e. viral load below detection level). This is expected to be the case when the virus is sensitive to at least one of the given drugs K in the chain k. To account for deviations from this model and since medical records are prone to errors, we model the observed (actual) outcome Oₜ, as a noisy version of the expected outcome Oₜ^{E}. Equation 3 below models the expected therapy outcome Oₜ^{E} that is determined based on the presence of a susceptibility, or lack thereof, of the pathogen to at least one of drugs k being taken by the patient at time t, i.e. V_{{k:d}_{_{t,k=1}}}m_{t,k}. Using the expected therapy outcome Oₜ^{E} in Equation 4, we denote the probability of the therapy outcome observed in the electronic health records data, i.e. Oₜ, being equal to the expected therapy outcome Oₜ^{E} by p^{N}.

Oₜ^{E}=V_{{k:d}_{_{t,k=1}}}m_{t,k} (3)

Pr(Oₜ=Oₜ^{E}|mₜ,dₜ)=p^{N} (4)

Note that at any given time t, the observed treatment outcome Oₜ depends only on a small number of variables, i.e. m_{t,k} (typically 2-3), associated with the drugs in the CART. The generative process of the model is as follows:

1. For all drug compounds k∈1, . . . , K:
a. Draw mutation probability pₖ^{M}˜Dir(β)
b. Draw prior resistance probability pₖ^{R}^{₀}˜Dir(γ)
   2. Draw outcome noise probability p^{N}˜η
   3. For all patients n=1, . . . , N
a. For t=1, . . . , T
   i. For all drugs k=1, . . . , K
      a. If t=1, draw R_{1,k}˜pₖ^{R}^{₀}, else draw R_{t,k}˜Pr(R_{t,k}|R_{t-1,k},Oₜ₋₁, M_{t-1,k})
   ii. Draw m_{t,k} conditioned on R_{t,k}, d_{t,k}
b. Draw treatment outcome Oₜ conditioned on m_{t,k}, d_{t,k}

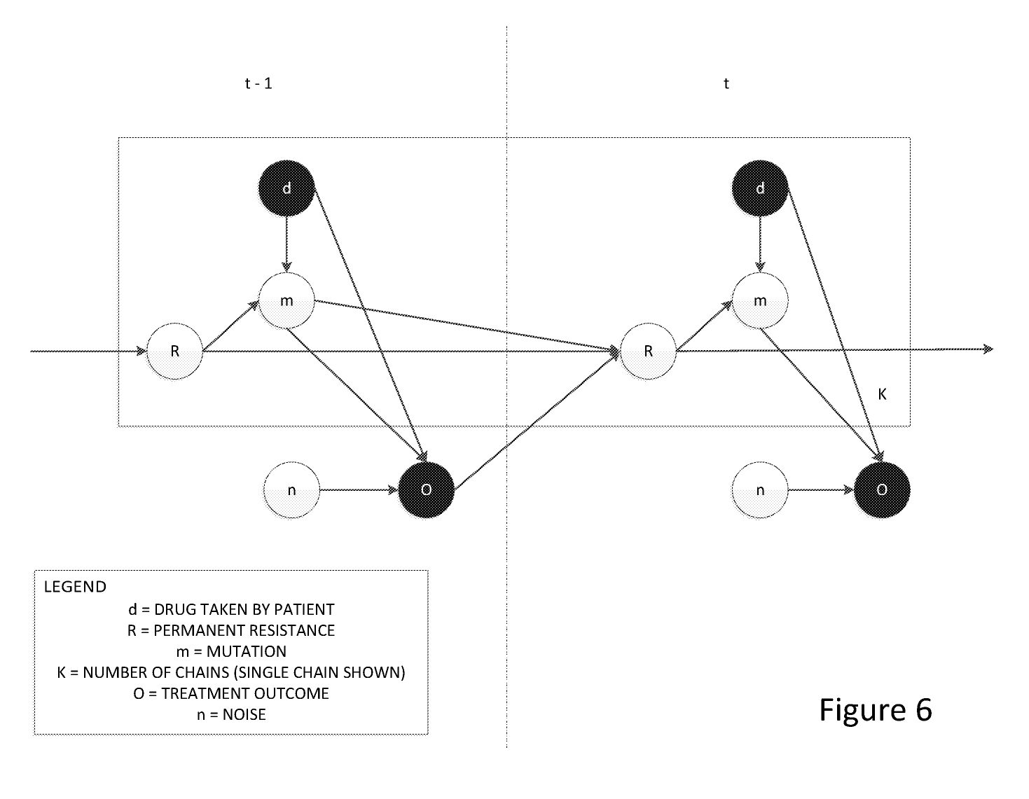

In the above equation, variables β, γ, η, θ, κ, and λ are Dirichlet priors that are treated as hyper-parameters of the model, or parameters of a prior distribution. FIG. 6 depicts the model exhibited above in plate notation. The parameter ε from equation 2 can either be set to a predefined constant or serve as a random variable taking part in the generative process of the previous section.

Referring now back to FIG. 2 and a general description of the invention herein, decision support program 132 retrieves population data from corpus 114 (step 204). In the example embodiment, decision support program 132 retrieves population data from corpus 114 in order to train the received pathogen drug resistance evolution model. Decision support program 132 retrieves population data from corpus 114 via network 108 based on a database location mapped by a user or programmer. In other embodiments, corpus 114 may be uploaded to decision support program 132 by a user or computing device. In further embodiments, decision support program 132 may retrieve population data on a recurring basis or upon specific triggers such as detection of new data being added to corpus 114. Corpus 114 may be located in public or private databases such as a medical record database maintained by medical professionals, medical associations, insurance companies, research facilities, federal and state databases, and the like. In the example embodiment, decision support program 132 retrieves population data detailing medical records from corpus 114 in order to train a model depicting a pathogen's drug resistance mutations. Accordingly, population data within corpus 114 may include medical records of a population such as test results, demographic information, current and previous treatments, outcomes to treatments, patient allergies, patient genetics, and the like.

With reference again to the illustrative example above, decision support program 132 is configured to retrieve population medical data from corpus 114 detailing patients diagnosed with HIV, including information such as prescribed treatments and outcomes.

Treatment prescription program 132 trains the pathogen drug resistance model using the population data (step 206). In the example embodiment, decision support program 132 trains the model by analyzing the population data of corpus 114 to learn appropriate model parameters. Decision support program 132 learns parameters of the model by applying one or more various approximate learning methods, such as expectation maximization (EM), variational EM, EM with Gibbs sampling, Gibbs Sampling, and others. In the example embodiment, however, decision support program 132 learns the parameters of the model using a collapsed Gibbs Sampling. In collapsed Gibbs sampling, discrete variables are sampled while the continuous variables are integrated out. More specifically, decision support program 132 block samples the latent discrete variables Rₜ,mₜ for a specific t (where Rₜ, mₜ are the collection of all hidden variables R_{t,k},m_{t,k} associated with a specific time t) while conditioning on all other variables (associated with all other times t′). The posterior probability from which these variables are sampled is illustrated by Equation 5:

Pr(Rₜ,mₜ|Rₜ₋₁,Rₜ₊₁,Oₜ,Oₜ₋₁,mₜ₋₁,dₜ)∝Pr(Rₜ₊₁|Oₜ,mₜ,Rₜ)Pr(Oₜ|mₜ,dₜ)Pr(mₜ|Rₜ,dₜ)Pr(Rₜ|Rₜ₋ᵢ,Oₜ₋₁,mₜ₋₁) (5)

Continuing the earlier-introduced example wherein decision support program 132 models the drug resistance evolution of the pathogen HIV, decision support program 132 trains the model to learn the parameters p^{M} p^{RO} and p^{N} using a collapsed Gibbs Sampling approximate learning method.

FIG. 3 depicts a flowchart illustrating the operation of decision support program 132 of decision support system 100 in providing decision support for long term drug therapy, in accordance with an embodiment of the present invention.

In the example embodiment, decision support program 132 receives patient data (step 302). Decision support program 132 receives patient data in order to infer a long term treatment of a patient by feeding the received patient data to the model trained with population data. In the example embodiment, decision support program 132 receives patient data remotely from user of computing device 110 via user interface 112 and network 108. In other embodiments, decision support program 132 may retrieve patient data on a recurring basis or upon triggers such as uploading of new data or detection of an appointment with a particular patient. Patient data may include test results, current and previous treatments, outcomes to current and previous treatments, patient demographic data, patient activity data, and the like.

With reference to the HIV example previously introduced, a doctor uploads a patient's data to decision support program 132 describing the medical history and up to date medical information of the patient's conditions as it relates to HIV.

Decision support program 132 prescribes a treatment therapy based on implicit information regarding a patient's health that is inferred from feeding the patient's data to the model (step 304). In the example embodiment, decision support program 132 prescribes several therapies each consisting of a list of drugs ranked by probability of success. Decision support program 132 employs a dynamic programming algorithm to predict a therapy that improves long term health for the patient. The model is used to design an entire series of treatments, possibly different from each other, that would optimize patient's health over an entire time period in contrast to optimizing only for the first treatments. Due to the Markovian structure of the invention, optimizing such a sequence of treatments is a finite Markov Decision Process (MDP) that may be solved using dynamic programming to find a policy that would maximize the total cumulative reward. In the example embodiment, decision support program 132 solves the optimization problem defined in Equation 6 using dynamic programming to design an optimal long term treatment for a patient by finding the sequence of actions (treatments) yielding an overall maximal reward (maximal cumulative patient health along an entire time period). Let qₜ=(m, R, a)ₜ be the state at time t, aₜ∈A be the multidrug treatment taken at time t, and Oₜ (qₜ, aₜ) be the outcome of treatment qₜ if the patient is at state qₜ at time t. Let the immediate reward of a treatment aₜ be 1 if the treatment is successful and 0 otherwise, and the expected reward of a state qₜ and action aₜ is E(Oₜ,|qₜ, aₜ, . . . , a_{T}). The value of state qₜ at time t is defined as the expected outcome of the best treatment (optimized over all possible actions).

$${V}_{t} ( {q}_{t} ) = {max}_{{a}_{t} , … , {a}_{T}} {\sum }_{{t}^{′} = t}^{T} E ( {O}_{t} , \vert {q}_{t} , {a}_{t} , … , {a}_{T} ) \qquad ( 6 )$$

Continuing the example above, decision support program 132 first feeds the patient data into the trained model in order to infer the drug resistance profile of the strain of HIV's contracted by the patient. Decision support program 132 then outputs a ranked list of therapies consisting of a list of drugs that the strain of HIV is likely to remain susceptible toward, and outputs this ranked list of therapies drugs to user interface 112 via network 108 for the doctor to reference in order to decide on a long term therapy for the patient.

Decision support program 132 observes an outcome of a prescribed therapy (step 306). In the example embodiment, decision support program 132 compares a patients previous medical condition to the patient's current medical condition to observe a change in the state of the patient's condition with regard to the pathogen being treated. In the example embodiment, some pathogens may not be curable but simply improved and thus what is considered a successful treatment is dependent on the subject pathogen. Based on the comparison, decision support program 132 infers whether a prescribed therapy has improved or worsened the medical condition of the patient with respect to the target pathogen.

Continuing the previously introduced example regarding a patient having HIV, if decision support program 132 determines that a prescribed therapy fails to suppress the virus, i.e. it does not reduce HIV levels in the blood, then decision support program 132 infers said prescribed treatment is a failure. Conversely, if decision support program 132 determines that the treatment has suppressed the virus, i.e. reduced HIV levels in the blood, then decision support program 132 infers that the treatment is a success. Decision support program 132 refines the model each time it determines whether a prescribed therapy is a success or failure (step 308). In the example embodiment, decision support program 132 transmits the outcome of a prescribed therapy to corpus 122 as part of population data from which the model is trained. Upon reassessment of the model, decision support program 132 includes the observed outcome and the model is refined accordingly. In other embodiments, observed outcomes may be explicitly fed into decision support program 132 for immediate analysis and refinement of the pathogen drug resistance evolution model.

With reference again to the example above regarding HIV, if decision support program 132 infers that a prescribed therapy for a strain of HIV in the patient is ineffective because said strain of HIV evolved resistance to all drug in said prescribed therapy, then decision support program 132 refines the model to reflect that the particular CART is ineffective against those with similar medical conditions to those of the patient. Conversely, if decision support program 132 infers that a prescribed therapy for a strain of HIV in the patient is effective, then decision support program 132 refines the model to reflect that the particular CART is effective against those with similar medical conditions as those of the patient.

While the above descriptions highlight use of the invention through an example regarding HIV, it will be appreciated by those of ordinary skill in the art that the invention lends itself to many different variations not specifically illustrated herein. In practice, the invention described herein may be used to provide decision support for any long term pathogen capable of acquiring resistances to treatments. For example, combined targeted therapies are becoming more and more common in the treatment of cancer. One such example is the combination therapy trametinib plus dabrafenib which is FDA approved for the treatment of Melanoma. In addition, numerous combination therapies are currently being tested in clinical trials. Unfortunately, the initial clinical response to targeted therapies is mostly temporary, as acquired resistance mutations to these drugs invariably develops. Thus, prioritizing drug combinations and developing sequential drug schedules could offer a way to maintain effective long term therapy.

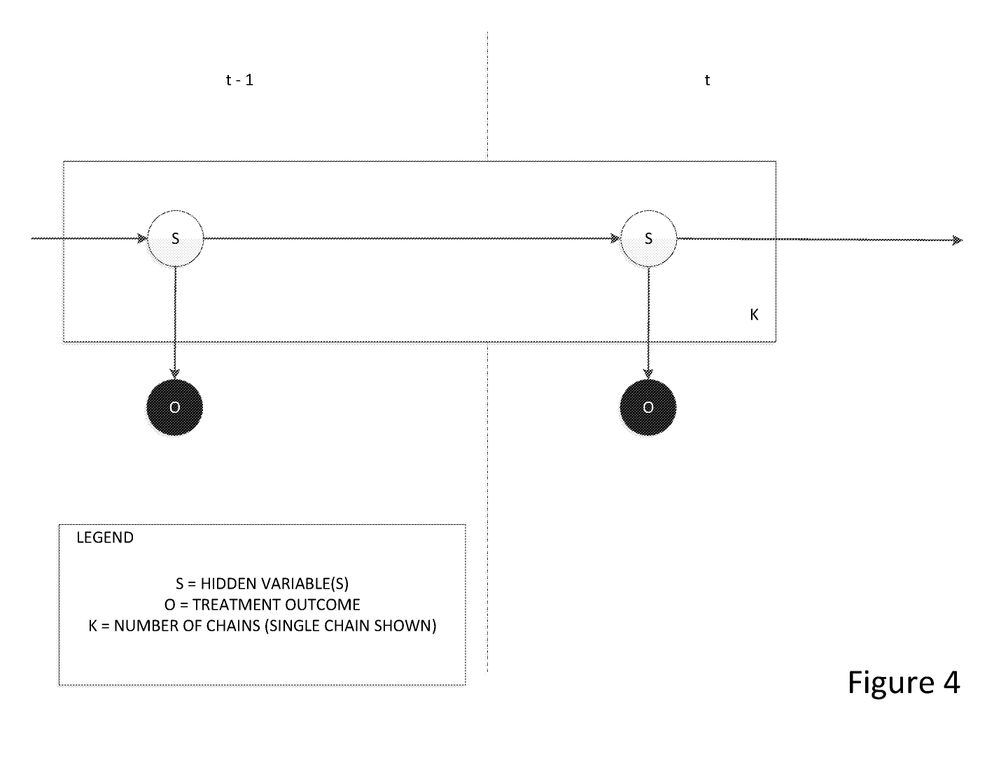

FIG. 4 depicts a factorial HMM in plates notation describing the relationship between several parameters of the model, in accordance with an embodiment of the present invention. In the example embodiment, a set of hidden variables s within a chain affect an outcome, O.

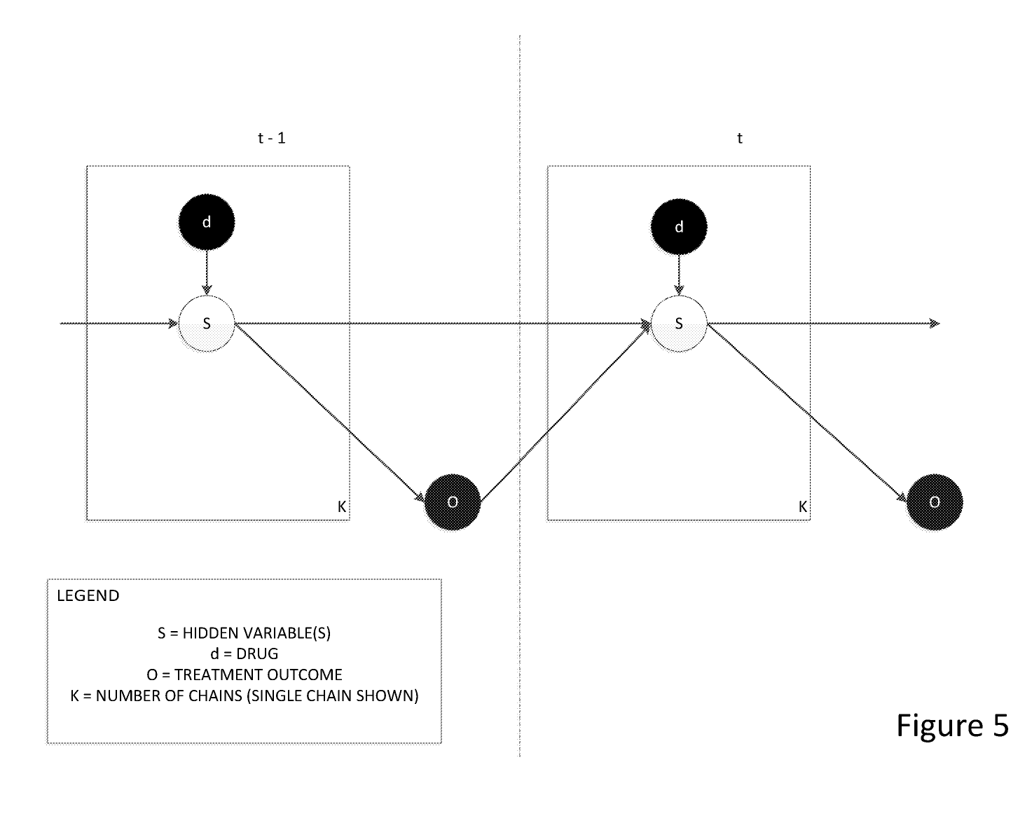

FIG. 5 depicts a factorial HMM in plates notation describing the relationship between a drug and several parameters in a multidrug therapy. In the example embodiment, a drug d affects a set of hidden variables s within a chain that affect an outcome O. The outcome O within time frame t−1 affects the hidden variables s within time frame t.

FIG. 6 depicts a factorial HMM in plates notation describing the relationships between a drug, permanent resistance, drug-resistant mutations, treatment outcome, and model noise to model the effect of a treatment on a patient's health. In the example embodiment, the variables within each of the K chains of the factorial HMM are: presence of a drug d (assumed to be known), permanent resistance R (unobserved), and evolution of a drug-resistant mutation m (unobserved). During time t, the presence of drug d and reservoirs of infection having permanent resistance R affect the evolution of a drug-resistant mutation m in a pathogen. The outcome of a treatment O in turn depends on the presence of a drug-resistant mutation m in the pathogen, the presence of a drug d and the noise n. Said outcome of a therapy O thereby affects permanent resistance R during a future time t+1 of the next treatment. For example, when treating a patient for HIV during a certain time t, the presence of a drug d may allow for HIV to evolve drug-resistant mutations m against said drug and therefore affect the outcome O of said treatment. If the virus has developed permanent resistance R, the HIV has already evolved drug-resistant mutations m against said drug and will inevitably affect the outcome O of said treatment. In turn, in the cases where the virus had not acquired permanent resistance at time t, the outcome of said treatment O will affect whether or not the HIV has permanent resistance against said drug d of the next treatment during time t+1. If the outcome O of the treatment during time t is successful, i.e. O=1, then the HIV has not developed permanent resistance, against the drug d. Inversely, if the outcome of the treatment during time t fails due to a drug resistant mutation m, i.e. O=0, then the HIV has developed permanent resistance R against the drug d.

While the present invention has been described and illustrated with reference to particular embodiments, it will be appreciated by those of ordinary skill in the art that the invention lends itself to many different variations not specifically illustrated herein.

The present invention may be a system, a method, and/or a computer program product. The computer program product may include a computer readable storage medium (or media) having computer readable program instructions thereon for causing a processor to carry out aspects of the present invention.

FIG. 7 depicts a block diagram of computing device 110, server 120, and/or server 130 of the decision support system 100 of FIG. 1, in accordance with an embodiment of the present invention. It should be appreciated that FIG. 7 provides only an illustration of one implementation and does not imply any limitations with regard to the environments in which different embodiments may be implemented. Many modifications to the depicted environment may be made.

Computing device 110 may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11, for example decision support program 132, are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Computing device 110 may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Computing device 110 may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

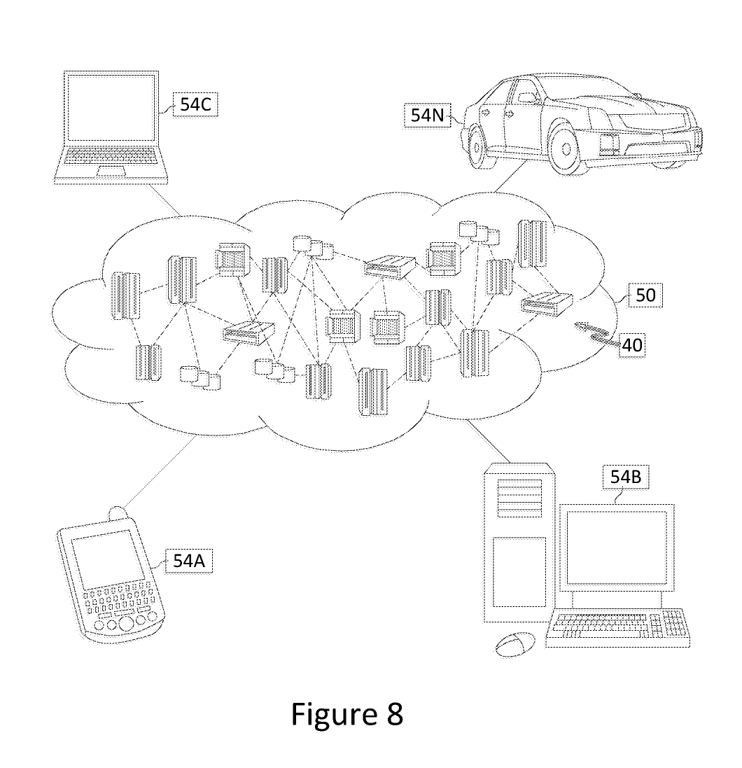

Referring now to FIG. 8, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 40 and cloud computing environment 50 can communicate with any type of computerized device over any type of network and/or network addressable connection (e.g., using a web browser).

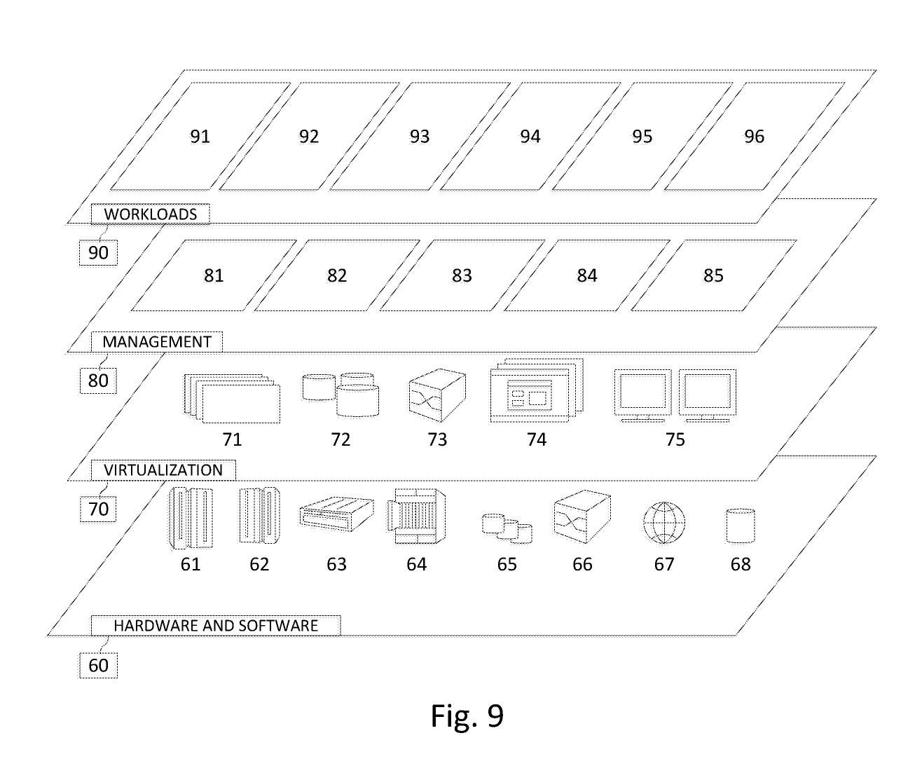

Referring now to FIG. 9, a set of functional abstraction layers provided by cloud computing environment 50 (FIG. 4) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and decision support processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1) A method for long term therapy decision support, the method comprising:
a computer receiving patient medical data;
the computer feeding the received patient medical data into a resistance evolution model; and
the computer recommending a therapy based on an output of the resistance evolution model.

2) The method of claim 1, further comprising:
the computer determining a result of the recommended therapy; and
the computer refining the resistance evolution model based on the determined result of the recommended therapy.

3) The method of claim 1, wherein the resistance evolution model is generated by:
the computer receiving programming defining the resistance evolution model;
the computer retrieving population data; and
the computer determining one or more parameters corresponding to the resistance evolution model based on the population data.

4) The method of claim 3, wherein the received programming defining the resistance evolution model comprises one or more stochastic models.

5) The method of claim 4, wherein the one or more stochastic models includes a Factorial Hidden Markov Model.

6) The method of claim 3, wherein determining one or more parameters corresponding to the resistance evolution model is performed via one or more approximate learning methods.

7) The method of claim 6, wherein the one or more approximate learning methods include Collapsed Gibbs Sampling.

8) A computer program product for long term therapy decision support, the computer program product comprising:
one or more computer-readable storage media and program instructions stored on the one or more computer-readable storage media, the program instructions comprising:
program instructions to receive patient medical data;
program instructions to feed the received patient medical data into a resistance evolution model; and
program instructions to recommend a therapy based on an output of the resistance evolution model.

9) The computer program product of claim 8, further comprising:
program instructions to determine a result of the recommended therapy; and
program instructions to refine the resistance evolution model based on the determined result of the recommended therapy.

10) The computer program product of claim 8, wherein the resistance evolution model is generated by:
program instructions to receive programming defining the resistance evolution model;
program instructions to retrieve population data; and
program instructions to determine one or more parameters corresponding to the resistance evolution model based on the population data.

11) The computer program product of claim 10, wherein the received programming defining the resistance evolution model comprises one or more stochastic models.

12) The computer program product of claim 11, wherein the one or more stochastic models includes a Factorial Hidden Markov Model.

13) The computer program product of claim 10, wherein determining one or more parameters corresponding to the resistance evolution model is performed via one or more approximate learning methods.

14) The computer program product of claim 13, wherein the one or more approximate learning methods include Collapsed Gibbs Sampling.

15) A computer system for long term therapy decision support, the computer system comprising:
one or more computer processors, one or more computer-readable storage media, and program instructions stored on one or more of the computer-readable storage media for execution by at least one of the one or more processors, the program instructions comprising:
program instructions to receive patient medical data;
program instructions to feed the received patient medical data into a resistance evolution model; and
program instructions to recommend a therapy based on an output of the resistance evolution model.

16) The computer system of claim 15, further comprising:
program instructions to determine a result of the recommended therapy; and
program instructions to refine the resistance evolution model based on the determined result of the recommended therapy.

17) The computer system of claim 15, wherein the resistance evolution model is generated by:
program instructions to receive programming defining the resistance evolution model;
program instructions to retrieve population data; and
program instructions to determine one or more parameters corresponding to the resistance evolution model based on the population data.

18) The computer system of claim 17, wherein the received programming defining the resistance evolution model comprises one or more stochastic models.

19) The computer system of claim 18, wherein the one or more stochastic models includes a Factorial Hidden Markov Model.

20) The computer system of claim 17, wherein determining one or more parameters corresponding to the resistance evolution model is performed via one or more approximate learning methods, and wherein the one or more approximate learning methods include Collapsed Gibbs Sampling.
